(19) United States
(12) Patent Application Publication
(10) Pub. No.: US 2024/0283155 A1
(43) Pub. Date: Aug. 22, 2024

(54) COUPLED FEEDING MULTI-BAND ANTENNA AND COUPLED FEEDING MULTI-BAND CIRCULARLY-POLARIZED SPIRAL ANTENNA

(71) Applicant: Inpaq Technology (Suzhou) Co., Ltd, Suzhou (CN)

(72) Inventors: Long TANG, Suzhou (CN); Shuo LIU, Suzhou (CN); Hongfeng ZHU, Suzhou (CN)

(73) Assignee: Inpaq Technology (Suzhou) Co., Ltd, Suzhou (CN)

(21) Appl. No.: 18/648,436

(22) Filed: Apr. 28, 2024

Related U.S. Application Data
(63) Continuation of application No. PCT/CN2023/102602, filed on Jun. 27, 2023.

(30) Foreign Application Priority Data
Jan. 31, 2023 (CN) 2023100483294

(51) Int. Cl. H01Q 5/50; H01Q 1/38; H01Q 15/24

(52) U.S. Cl. CPC H01Q 5/50; H01Q 1/38; H01Q 15/242

(57) ABSTRACT

The present invention provides a coupled feeding multi-band antenna and a coupled feeding multi-band circularly-polarized spiral antenna. The coupled feeding multi-band antenna includes multiple multi-band antenna groups, where each multi-band antenna group forms a multi-band co-feeding antenna with a grounding branch through a coupled feed-in electrode, the coupled feed-in electrode is arranged on one surface of a substrate portion, and the grounding branch is arranged on the other surface of the substrate portion. In this way, a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance. Furthermore, a small-sized coupled feeding multi-band antenna is achieved, and besides, miniaturization of broadband circular polarization is achieved.

### CROSS-REFERENCE TO RELATED APPLICATIONS

The application claims priority to Chinese patent application No. 2023100483294, filed on Jan. 31, 2023, the entire contents of which are incorporated herein by reference.

### TECHNICAL FIELD

The present invention relates to the technical field of wireless communication, in particular to a coupled feeding multi-band antenna and a coupled feeding multi-band circularly-polarized spiral antenna.

### BACKGROUND

With development of satellite communication, and remote control and telemetry technologies, expansion of a radar application scope, and requirements for tracking and measurement of high-speed targets under various polarization modes and climate conditions, antennas in a single polarization mode are far from meeting the requirements, and therefore, the application of a coupled feeding multi-band antenna becomes very important. Compared with a linearly-polarized antenna, the coupled feeding multi-band antenna can eliminate polarization distortion losses caused by a Faraday rotation effect in an ionosphere in satellite communication applications. The coupled feeding multi-band antenna can reduce signal leakage in communication, remote sensing, radar and other system applications; in electronic countermeasures, the coupled feeding multi-band antenna can detect and interfere with various linearly-polarized signals and elliptically-polarized signals of the enemy; and a circularly-polarized antenna can receive signals on carriers that swing or roll violently.

The circularly-polarized antenna has unique advantages in combating rain, fog, ionosphere, etc., not only can resist interference of multipath effects, but also has a large channel capacity; in a modern communication system, the circularly-polarized antenna has the following technical problems:
1) impedance matching of the circularly-polarized antenna is difficult to adjust and design difficulties of feeding networks and feeding structures cannot be overcome;
2) a small-sized circularly-polarized antenna is difficult to achieve, and miniaturization of broadband circular polarization cannot be achieved;
3) in the modern communication system, channel capacity of a single-band antenna communication system is poor, anti-interference ability is weak, and single-band antennas cannot meet practical needs during operation; and
4) in terms of unmanned driving and high-precision positioning, development of a broadband coupled feeding multi-band antenna which meets requirements of people has become a current challenge due to the limitations of PCV, low-elevation gain, and axial ratio bandwidth.

### SUMMARY

In order to solve the technical problem, according to a coupled feeding multi-band antenna and a coupled feeding multi-band circularly-polarized spiral antenna provided by the present invention, a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance. Furthermore, a small-sized coupled feeding multi-band antenna is achieved, and besides, miniaturization of broadband circular polarization is achieved.

In order to realize the purposes mentioned above, the present invention adopts the following technical solution:

the present invention provides a coupled feeding multi-band antenna, including multiple multi-band antenna groups, where each multi-band antenna group forms a multi-band co-feeding antenna with a grounding branch through a coupled feed-in electrode, the coupled feed-in electrode is arranged on one surface of a substrate portion, and the grounding branch is arranged on the other surface of the substrate portion.

According to the coupled feeding multi-band antenna and the coupled feeding multi-band circularly-polarized spiral antenna provided by the present invention, a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance. Furthermore, a small-sized coupled feeding multi-band antenna is achieved, and besides, miniaturization of broadband circular polarization is achieved.

As a preferred technical solution, the multi-band antenna groups are arranged on the other surface of the substrate portion, and are connected to the grounding branches.

As a preferred technical solution, the coupled feed-in electrodes are arranged at an end of said one surface of the substrate portion, the multi-band antenna groups are arranged at one end of said the other surface of the substrate portion, and the grounding branches are arranged at the other end of said the other surface of the substrate portion.

As a preferred technical solution, the multi-band antenna groups comprise a plurality of branch antennas of different lengths, where multiple branch antennas of different lengths form a corresponding multi-band antenna group, the long branch antennas in the multi-band antenna group are low-band antennas, and the short branch antennas in the multi-band antenna group are high-band antennas.

As a preferred technical solution, a plurality of positioning holes are formed in two sides of the substrate portion oppositely, and edges of the positioning holes in one side of the substrate portion overlap with those of the positioning holes in the other side of the substrate portion to form the coupled feeding multi-band antenna.

The present invention provides a coupled feeding multi-band circularly-polarized spiral antenna, which includes a feeding network portion and any one above-mentioned coupled feeding multi-band antenna, where the coupled feeding multi-band antenna is arranged on the feeding network portion and connected to the feeding network portion through the coupled feed-in electrodes to realize single-feeding output.

As a preferred technical solution, the coupled feeding multi-band antenna is cylindrical, and the branch antennas on a side wall of the coupled feeding multi-band antenna are in spiral distribution.

As a preferred technical solution, the side wall of the coupled feeding multi-band antenna is evenly divided by the branch antennas.

As a preferred technical solution, the feeding network portion consists of a power divider and a phase shifter, the power divider and the phase shifter control phases and power synthesis of each spiral arm port of the branch antennas to achieve left-handed radiation or right-handed radiation of the multi-band antenna groups.

As a preferred technical solution, the coupled feeding multi-band circularly-polarized spiral antenna includes a circuit board, where the feeding network portion is arranged on the circuit board, and the grounding branches are arranged on the feeding network portion and connected to the feeding network portion.

As a preferred technical solution, the coupled feeding multi-band circularly-polarized spiral antenna includes a base and a protective cover, where the circuit board is connected to the base, and the protective cover sequentially covers the coupled feeding multi-band antenna, the feeding network portion, and the circuit board, and is connected to the base.

The coupled feeding multi-band antenna and the coupled feeding multi-band circularly-polarized spiral antenna, provided by the present invention, have the following beneficial effects:
1) according to the coupled feeding multi-band antenna and the coupled feeding multi-band circularly-polarized spiral antenna provided by the present invention, a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance, furthermore, a small-sized coupled feeding multi-band antenna is achieved, and besides, miniaturization of broadband circular polarization is achieved;
2) according to the coupled feeding multi-band antenna and the coupled feeding multi-band circularly-polarized spiral antenna provided by the present invention, a spiral antenna is selected to achieve better PCV and higher low-elevation gain and axial ratio width; the power divider and the phase shifter adjust phases and power synthesis of each spiral arm port of the spiral branch antennas to achieve left-handed radiation or right-handed radiation of the multi-band antenna groups;
3) according to the coupled feeding multi-band antenna and the coupled feeding multi-band circularly-polarized spiral antenna provided by the present invention, a feeding manner of the antenna adopts coupled feeding, that is, the branch antenna of each antenna group consists of two parts: the coupled feed-in electrode and the grounding branch, and the coupled feed-in electrode is not connected to the grounding branch, which improves impedance matching and circularly-polarized radiation performance of the coupled feeding multi-band antenna; and
4) according to the coupled feeding multi-band antenna and the coupled feeding multi-band circularly-polarized spiral antenna provided by the present invention, the branch antennas of different lengths in the multi-band antenna group achieve performance of multiple bands of feeding; the multi-band antenna group is combined with the grounding branch through the coupled feed-in electrode to realize the coupled feeding multi-band antenna with multiple bands simultaneously; and not only channel capacity and anti-interference ability of an antenna communication system are improved, but also design difficulties of a feeding network and a feeding structure are overcome, and good impedance matching and circularly-polarized radiation performance are achieved.

### BRIEF DESCRIPTION OF DRAWINGS

FIG. 1 shows a schematic diagram of a coupled feeding multi-band antenna (dual-band antenna) proposed by the present invention;

FIG. 2 shows a schematic diagram of a coupled feeding multi-band antenna (multi-band antenna) proposed by the present invention;

FIG. 3 shows a partial schematic structural diagram of a coupled feeding multi-band circularly-polarized spiral antenna provided by the present invention;

FIG. 4 shows a schematic diagram of the coupled feeding multi-band circularly-polarized spiral antenna provided by the present invention, where a power divider and a phase shifter control phases and power synthesis of each spiral arm port of branch antennas to achieve left-handed radiation or right-handed radiation of multi-band antenna groups;

FIG. 5 shows a return loss simulation result diagram of the coupled feeding multi-band circularly-polarized spiral antenna provided by the present invention;

FIG. 6 shows an axial ratio-high band simulation result diagram of the coupled feeding multi-band circularly-polarized spiral antenna provided by the present invention;

FIG. 7 shows an axial ratio-low band simulation result diagram of the coupled feeding multi-band circularly-polarized spiral antenna provided by the present invention;

FIG. 8 shows a 2D pattern-high band simulation result diagram of the coupled feeding multi-band circularly-polarized spiral antenna provided by the present invention;

FIG. 9 shows a 2D pattern-low band simulation result diagram of the 2D pattern-low band of the coupled feeding multi-band circularly-polarized spiral antenna provided by the present invention; and

in the drawings, 1—substrate portion; 2—one surface of substrate portion; 3—the other surface of substrate portion; 4—coupled feed-in electrode; 5—multi-band antenna group; 6—grounding branch; 7—positioning hole; 8—branch antenna; 9—feeding network portion; 10—circuit board; 11—coupled feeding multi-band antenna.

### DETAILED DESCRIPTION OF THE EMBODIMENTS

The preferred embodiments of the present invention are described in detail below, in conjunction with the accompanying drawings.

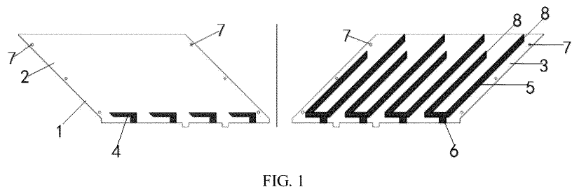

It can be understood that the present invention is described through some embodiments. In order to achieve the objective of the present invention, as shown in FIG. 1, the present invention provides a coupled feeding multi-band antenna, including: multiple multi-band antenna groups 5, where each multi-band antenna group 5 forms a multi-band co-feeding antenna with a grounding branch 6 through a coupled feed-in electrode 4, the coupled feed-in electrode 4 is arranged on one surface of a substrate portion 1, and the grounding branch 6 is arranged on the other surface of the substrate portion 1; the multi-band antenna groups 5 are arranged on the other surface of the substrate portion 1, and are connected to the grounding branches 6; the coupled feed-in electrodes 4 are arranged at an end of said one surface of the substrate portion 1, the multi-band antenna groups 5 are arranged at one end of said the other surface of the substrate portion 1, and the grounding branches 6 are arranged at the other end of said the other surface of the substrate portion 1; the multi-band antenna groups 5 include a plurality of branch antennas 8 of different lengths, where two branch antennas 8 of different lengths form a corresponding multi-band antenna group 5, the long branch antenna in the multi-band antenna group 5 is a low-band antenna, and the short branch antenna in the multi-band antenna group is a high-band antenna; a plurality of positioning holes 7 are formed in two sides of the substrate portion 1 oppositely; a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance. Furthermore, a small-sized coupled feeding multi-band antenna is achieved, and besides, miniaturization of broadband circular polarization is achieved.

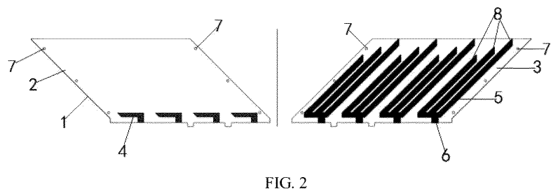

A coupled feeding multi-band antenna provided by the present invention is shown in FIG. 2. the present invention provides a coupled feeding multi-band antenna, including: multiple multi-band antenna groups 5, where each multi-band antenna group 5 forms a multi-band co-feeding antenna with a grounding branch 6 through a coupled feed-in electrode 4, the coupled feed-in electrode 4 is arranged on one surface of a substrate portion 1, and the grounding branch 6 is arranged on the other surface of the substrate portion 1; the multi-band antenna groups 5 are arranged on the other surface of the substrate portion 1, and are connected to the grounding branches 6; the coupled feed-in electrodes 4 are arranged at an end of said one surface of the substrate portion 1, the multi-band antenna groups 5 are arranged at one end of said the other surface of the substrate portion 1, and the grounding branches 6 are arranged at the other end of said the other surface of the substrate portion 1; the multi-band antenna groups 5 include a plurality of branch antennas 8 of different lengths, where multiple branch antennas 8 of different lengths form a corresponding multi-band antenna group 5, the long branch antennas in the multi-band antenna group 5 are low-band antennas, and the short branch antennas in the multi-band antenna group are high-band antennas; a plurality of positioning holes 7 are formed in two sides of the substrate portion 1 oppositely; in this way, a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance. Furthermore, a small-sized coupled feeding multi-band antenna is achieved, and besides, miniaturization of broadband circular polarization is achieved.

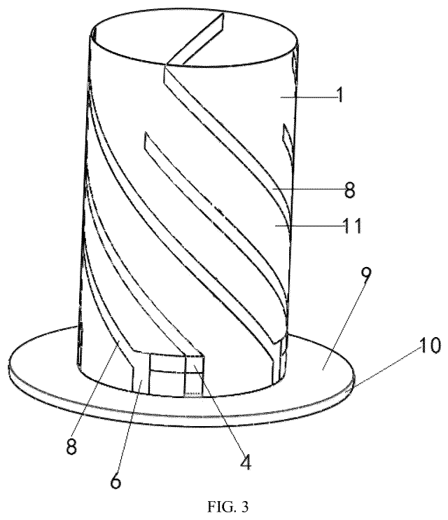

As shown in FIG. 3, the present invention provides a coupled feeding multi-band circularly-polarized spiral antenna, including a feeding network portion 9 and any one above-mentioned coupled feeding multi-band antenna, where the substrate portion is preferably a looped soft substrate portion, and edges of the positioning holes 7 in one side of the substrate portion 1 overlap with those of the positioning holes 7 in the other side of the substrate portion 1 to form the coupled feeding multi-band antenna 11; the coupled feeding multi-band antenna 11 is arranged on the feeding network portion 9 and connected to the feeding network portion 9 through the coupled feed-in electrodes 4 to realize single-feeding output; the coupled feeding multi-band antenna 11 is cylindrical, and the branch antennas 8 on a side wall of the coupled feeding multi-band antenna 11 are in spiral distribution; the side wall of the coupled feeding multi-band antenna 11 is evenly divided by the plurality of branch antennas 8; the feeding network portion 9 consists of a power divider and a phase shifter, the power divider and the phase shifter control phases and power synthesis of each spiral arm port of the branch antennas 8 to achieve left-handed radiation or right-handed radiation of the multi-band antenna groups 5; the feeding network portion 9 is arranged on a circuit board 10, and the grounding branches 6 are arranged on the feeding network portion 9 and connected to the feeding network portion 9; the circuit board 10 is connected to a base (not shown), a protective cover (not shown) sequentially covers the coupled feeding multi-band antenna 11, the feeding network portion 9, and the circuit board 10, and is connected to the base (not shown), where the feeding network portion 9 and the circuit board 10 are both made of an FR4 material (glass fiber epoxy resin material), and copper is laid on a surface or an inner layer of the FR4 material to form a double-layer or multi-layer board, so as to obtain the feeding network portion 9 and the circuit board 10; and in this way, not only channel capacity and anti-interference ability of an antenna communication system are improved, but also design difficulties of a feeding network and a feeding structure are overcome, and good impedance matching and circularly-polarized radiation performance are achieved. Furthermore, a small-sized coupled feeding multi-band antenna is achieved, and besides, miniaturization of broadband circular polarization is achieved.

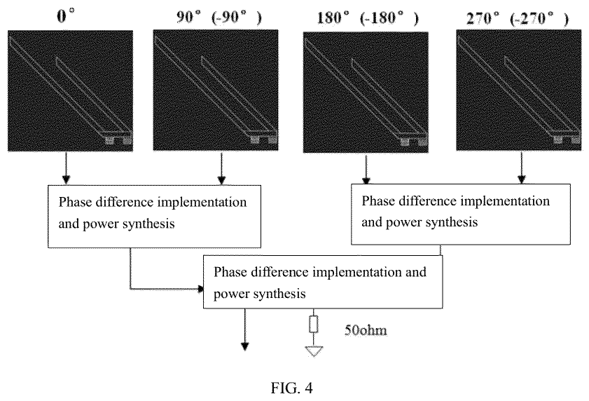

As shown in FIG. 4, we can observe that in the coupled feeding multi-band circularly-polarized spiral antenna provided by the present invention, the power divider and the phase shifter control phases and power synthesis of each spiral arm port of the branch antennas to achieve left-handed radiation or right-handed radiation of the multi-band antenna groups.

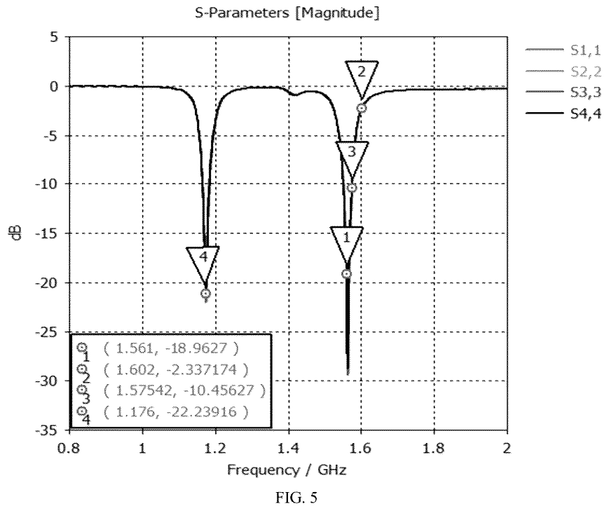

A return loss simulation result diagram of the coupled feeding multi-band circularly-polarized spiral antenna provided by the present invention is shown in FIG. 5, proving that the coupled feeding multi-band circularly-polarized spiral antenna provided in the application has good impedance matching performance.

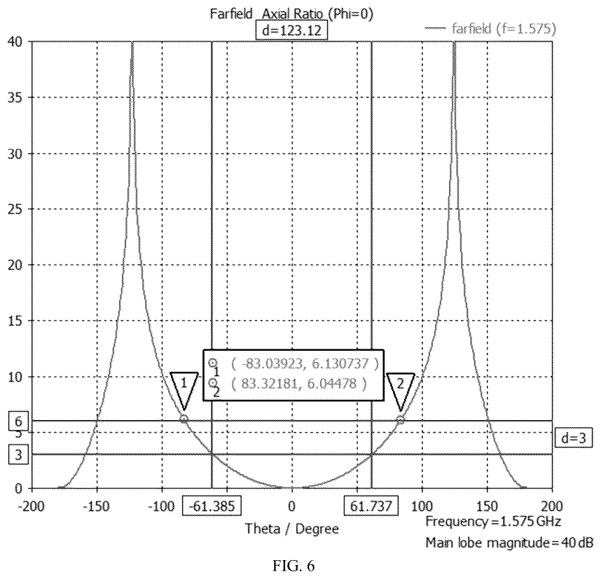

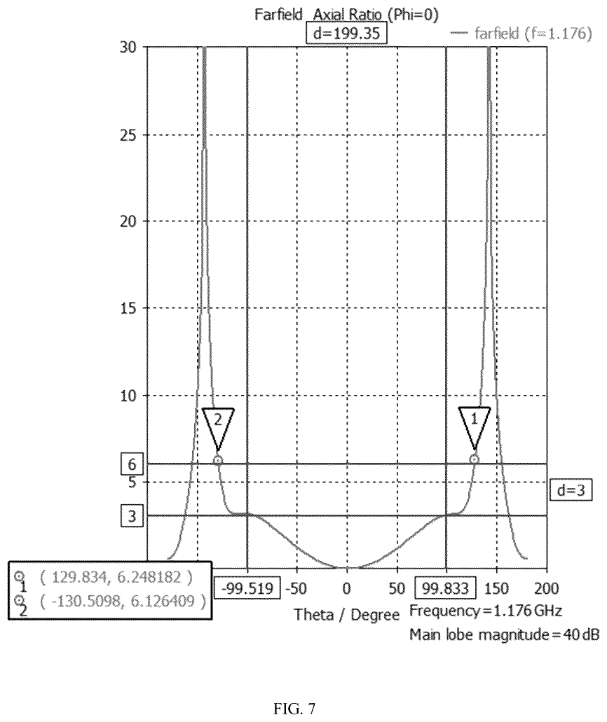

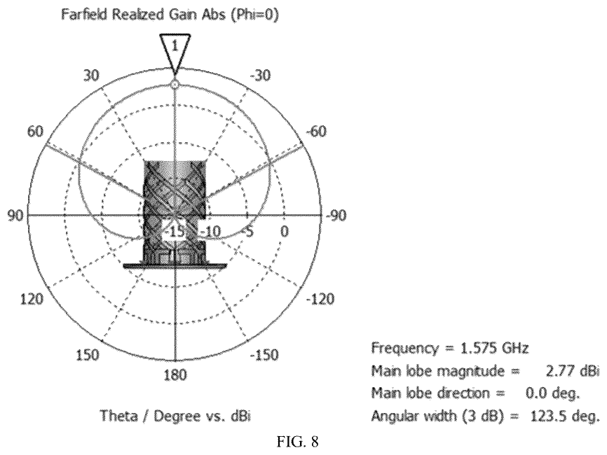

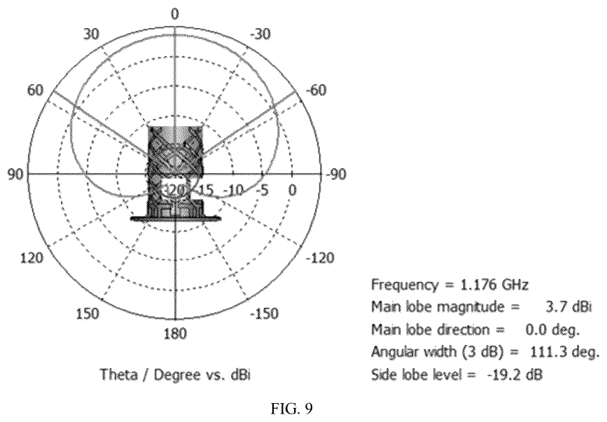

An axial ratio-high band simulation result diagram of the coupled feeding multi-band circularly-polarized spiral antenna provided by the present invention is shown in FIG. 6; an axial ratio-low band simulation result diagram of the coupled feeding multi-band circularly-polarized spiral antenna provided by the present invention is shown in FIG. 7; a 2D pattern-high band simulation result diagram of the coupled feeding multi-band circularly-polarized spiral antenna provided by the present invention is shown in FIG. 8; a 2D pattern-low band simulation result diagram of the coupled feeding multi-band circularly-polarized spiral antenna provided by the present invention is shown in FIG. 9; and as shown in FIGS. 6-9, it is proved that the coupled feeding multi-band circularly-polarized spiral antenna provided by the present invention has favorable circularly-polarized radiation performance.

The coupled feeding multi-band antenna and the coupled feeding multi-band circularly-polarized spiral antenna, provided by the present invention, have the following beneficial effects:
1) according to the coupled feeding multi-band antenna and the coupled feeding multi-band circularly-polarized spiral antenna provided by the present invention, a broadband coupled feeding multi-band antenna that meets requirements of people is produced, which not only improves channel capacity and anti-interference ability of an antenna communication system, but also overcomes design difficulties of a feeding network and a feeding structure, achieving good impedance matching and circularly-polarized radiation performance, furthermore, a small-sized coupled feeding multi-band antenna is achieved, and besides, miniaturization of broadband circular polarization is achieved;
2) according to the coupled feeding multi-band antenna and the coupled feeding multi-band circularly-polarized spiral antenna provided by the present invention, a spiral antenna is selected to achieve better PCV and higher low-elevation gain and axial ratio width; the power divider and the phase shifter adjust phases and power synthesis of each spiral arm port of the spiral branch antennas to achieve left-handed radiation or right-handed radiation of the multi-band antenna groups;
3) according to the coupled feeding multi-band antenna and the coupled feeding multi-band circularly-polarized spiral antenna provided by the present invention, a feeding manner of the antenna adopts coupled feeding, that is, the branch antenna of each antenna group consists of two parts: the coupled feed-in electrode and the grounding branch, and the coupled feed-in electrode is not connected to the grounding branch, which improves impedance matching and circularly-polarized radiation performance of the coupled feeding multi-band antenna; and
4) according to the coupled feeding multi-band antenna and the coupled feeding multi-band circularly-polarized spiral antenna provided by the present invention, the branch antennas of different lengths in the multi-band antenna group achieve performance of multiple bands of feeding; the multi-band antenna group is combined with the grounding branch through the coupled feed-in electrode to realize the coupled feeding multi-band antenna with multiple bands simultaneously; and not only channel capacity and anti-interference ability of an antenna communication system are improved, but also design difficulties of a feeding network and a feeding structure are overcome, and good impedance matching and circularly-polarized radiation performance are achieved.

It can be understood that the present invention is described through some embodiments, and it will be obvious to those skilled in the art that various changes or equivalent replacements may be made to these features and embodiments without departing from the spirit and scope of the present invention. Furthermore, modifications may be made to, under the guidance of the present invention, these features and embodiments to adapt a particular situation and materials without departing from the spirit and scope of the present invention. Therefore, the present invention is not limited by the specific embodiments disclosed herein, and all changes or equivalent substitutions within the scope of the claims of the present application fall within the scope of protection of the present invention. Furthermore, modifications may be made to, under the guidance of the present invention, these features and embodiments to adapt a particular situation and materials without departing from the spirit and scope of the present invention. Therefore, the present invention is not limited by the specific embodiments disclosed herein, and all embodiments within the scope of the claims of the present application fall within the scope of protection of the present invention.

What is claimed is:

1. A coupled feeding multi-band antenna, comprising: multiple multi-band antenna groups, wherein each multi-band antenna group forms a multi-band co-feeding antenna with a grounding branch through a coupled feed-in electrode, the coupled feed-in electrode is arranged on one surface of a substrate portion, and the grounding branch is arranged on the other surface of the substrate portion.

2. The coupled feeding multi-band antenna according to claim 1, wherein the multi-band antenna groups are arranged on the other surface of the substrate portion, and are connected to the grounding branches.

3. The coupled feeding multi-band antenna according to claim 2, wherein the coupled feed-in electrodes are arranged at an end of said one surface of the substrate portion, the multi-band antenna groups are arranged at one end of said the other surface of the substrate portion, and the grounding branches are arranged at the other end of said the other surface of the substrate portion.

4. The coupled feeding multi-band antenna according to claim 2, wherein the multi-band antenna groups comprise a plurality of branch antennas of different lengths, where multiple branch antennas of different lengths form a corresponding multi-band antenna group, the long branch antennas in the multi-band antenna group are low-band antennas, and the short branch antennas in the multi-band antenna group are high-band antennas.

5. The coupled feeding multi-band antenna according to claim 4, wherein a plurality of positioning holes are formed in two sides of the substrate portion oppositely, and edges of the positioning holes in one side of the substrate portion overlap with those of the positioning holes in the other side of the substrate portion to form the coupled feeding multi-band antenna.

6. A coupled feeding multi-band circularly-polarized spiral antenna, comprising: a feeding network portion and the coupled feeding multi-band antenna according to claim 1, wherein the coupled feeding multi-band antenna is arranged on the feeding network portion and connected to the feeding network portion through the coupled feed-in electrodes to realize single-feeding output.

7. The coupled feeding multi-band circularly-polarized spiral antenna according to claim 6, wherein the coupled feeding multi-band antenna is cylindrical, and the branch antennas on a side wall of the coupled feeding multi-band antenna are in spiral distribution.

8. The coupled feeding multi-band circularly-polarized spiral antenna according to claim 7, wherein the side wall of the coupled feeding multi-band antenna is evenly divided by the branch antennas.

9. The coupled feeding multi-band circularly-polarized spiral antenna according to claim 6, wherein the feeding network portion consists of a power divider and a phase shifter, the power divider and the phase shifter adjust phases and power synthesis of each spiral arm port of the branch antennas to achieve left-handed radiation or right-handed radiation of the multi-band antenna groups.

10. The coupled feeding multi-band circularly-polarized spiral antenna according to claim 6, comprising: a circuit board, wherein the feeding network portion is arranged on the circuit board, and the grounding branches are arranged on the feeding network portion and connected to the feeding network portion.
